(19) United States
(12) Patent Application Publication
(10) Pub. No.: US 2017/0163424 A1
(43) Pub. Date: Jun. 8, 2017

(54) SECURE INFORMATION RETRIEVAL BASED ON HASH TRANSFORMS

(71) Applicant: Hewlett Packard Enterprise Development LP, Houston, TX (US)

(72) Inventors: Mehran Kafai, Redwood City, CA (US); Hongwei Shang, Palo Alto, CA (US); Apri Slayden Mitchell, San Jose, CA (US)

(73) Assignee: Hewlett Packard Enterprise Development LP, Houston, TX (US)

(21) Appl. No.: 15/327,015

(22) PCT Filed: Aug. 29, 2014
(86) PCT No.: PCT/US2014/053333

§ 371 Date: Jan. 17, 2017

(51) Int. Cl. H04L 9/32; G06F 17/30; G06F 21/62

(52) U.S. Cl. CPC H04L 9/3242; G06F 21/6245; G06F 17/30675

(57) ABSTRACT

Secure information retrieval is disclosed. One example is a system including an information retriever comprising a collection of nodes that receive a hash count from a first dataset, the first dataset including a first data term, and provide the hash count to a second dataset, the second dataset including a plurality of second data terms. A hash transformer transforms the data terms based on the hash count. A modifier modifies, for a given node, the transformed data terms. An evaluator evaluates, for each node, a similarity value between the first data term and each given second data term based on shared data elements between the modified first data term and a given modified second data term associated with the given second data term. The information retriever provides to the first dataset, at least one term identifier associated with a second data term.

### BACKGROUND

Secure information retrieval is a secure protocol that allows one party to retrieve information from a second party without revealing the data that supports the information.

### BRIEF DESCRIPTION OF THE DRAWINGS

FIG. 1 is a functional block diagram illustrating one example of a system for secure information retrieval.

FIG. 2 is a functional block diagram illustrating another example of a system for secure information retrieval.

FIG. 3 is a block diagram illustrating one example of a processing system for implementing the system for secure information retrieval.

FIG. 4 is a block diagram illustrating one example of a computer readable medium for secure information retrieval.

FIG. 5 is a flow diagram illustrating one example of a method for secure information retrieval.

### DETAILED DESCRIPTION

The need for computations on sensitive data from two or more individuals has grown in recent years. This problem is known as secure multi-party computation (“SMPC”). Closely related problems include secure multi-party comparison, secure two-party vector dominance, and private information retrieval (PIR). For example, the socialist millionaire problem is illustrative of an information retrieval problem. Two millionaires may want to know if they are equally wealthy without leaking any information about their respective wealth. Several algorithms, frameworks, and theoretical solutions have been proposed to help solve the information retrieval problem. One major issue with the theoretical solutions is related to their impracticality due to high computational complexity. Existing protocols are typically unable to perform efficient search over large sets of anonymized and/or encrypted data without information leakage.

As described in various examples herein, a method based on utilizing orthogonal transform based hashes is disclosed to compare entity objects in an anonymized manner. For example, the information retrieval problem may constitute determining the k objects in a second entity that are most similar to an object in the first entity, without revealing the identity of the k objects.

For example, in a healthcare setting, a first hospital may have a group of patients with certain symptoms/results. The first hospital may want to know if a second hospital has any similar patients with similar symptoms/results, for example, in order to identify cohorts. Based on the examples described herein, such a comparison is possible without either hospital revealing their protected patient data. If cohorts are identified, the first and second hospitals may then consider next steps for comparing recommended treatment options.

As another example, in a retail setting, a first retailer may sell their retail data to a third party company in order for this company to anonymize the retail data, and compare it to data from other similar companies. The third party company then sells such comparative information back to the first retailer. Based on the examples described herein, the first retailer may carry out such a comparison collaboratively with a second retailer, without the need for the third party company. For example, a first retailer with shopper profiles may want to know if a second retailer, say in a similar geographic area, has similar shopper profiles. In such an instance, the first and second retailers may compare their shopper profiles without revealing actual customer data. If similar shopper profiles are found, the first and second retailers may choose to collaborate on providing an offering that may bring shoppers to each of their retail stores.

Also, for example, two entities may want to compare a set of confidential lists and/or profiles and determine if there are similarities between the lists and/or profiles, without sharing the actual lists and/or profiles.

As described in various examples herein, a secure distributed framework is disclosed for computing the similarity between objects from different entities in an anonymous manner by utilizing multiple nodes. A hypergeometric distribution may be utilized to model similarity values between objects defined by their respective overlapping hash sets. For example, hash-based similarity with the hypergeometric distribution may be modeled based on multiple random permutations of a hash universe, generated by different nodes, to achieve secure and anonymous computation of similarity values. The examples described herein provide the ability to perform cost-effective retrieval in addition to anonymizing the data. No single node among the multiple nodes may be trusted. Also, for example, no node may have the ability to de-anonymize data to recreate the data retrieved.

As described in various examples herein, secure information retrieval is disclosed. One example is a system including an information retriever comprising a collection of nodes that receive a hash count from a first dataset, the first dataset including a first data term, and provide the hash count to a second dataset, the second dataset including a plurality of second data terms. A hash transformer transforms the data terms based on the hash count. A modifier modifies, for a given node, the transformed data terms. An evaluator evaluates, for each node, a similarity value between the first data term and each given second data term based on shared data elements between the modified first data term and a given modified second data term associated with the given second data term. The information retriever provides to the first dataset, at least one term identifier associated with a second data term.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

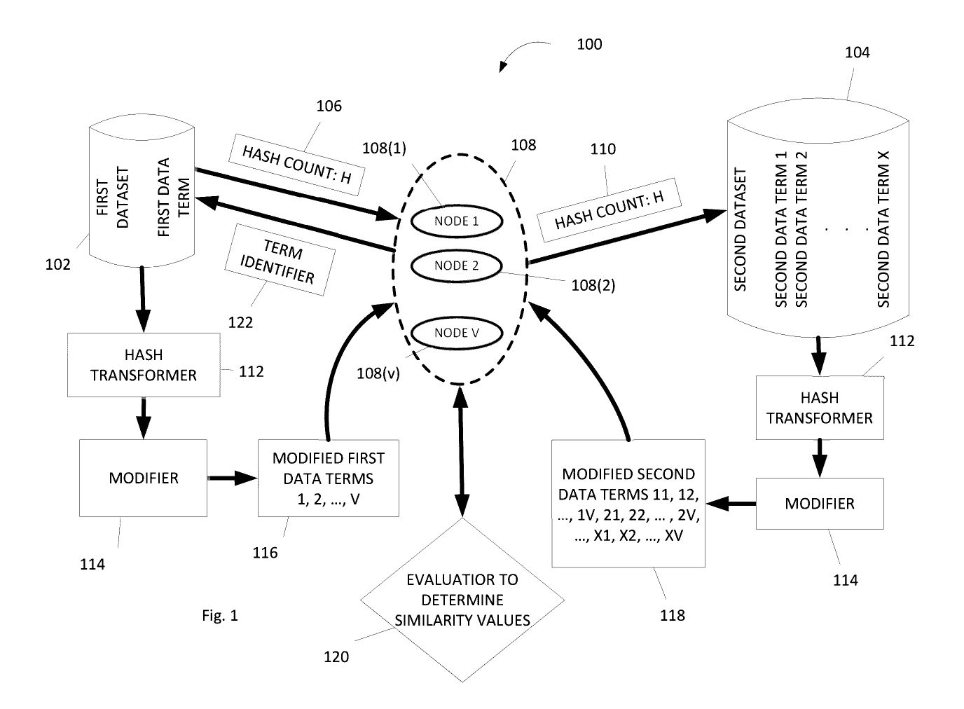

FIG. 1 is a functional block diagram illustrating one example of a system 100 for system for secure information retrieval. The system 100 receives a hash count from a first dataset, where the first dataset includes a first data term. In one example, the first data term may be an N-dimensional vector with numerical, real-valued components. System 100 provides the hash count to a second dataset, where the second dataset includes a plurality of second data terms. In one example, the plurality of second data terms may be a plurality of vectors with numerical, real-valued components. The system 100 transforms the first data term and the plurality of second data terms, where the transformation is based on the hash count. The system 100 modifies, for a given node of the collection of nodes, the transformed first data term and the plurality of transformed second data terms respectively, where the modification is based on the given node. System 100 provides, to the given node, the modified first data term and the plurality of modified second data terms. System 100 evaluates, for each node, a similarity value between the first data term and each given second data term, the similarity value indicative of proximity of the given second data term to the first data term, and based on shared data elements between the modified first data term and a given modified second data term associated with the given second data term. System 100 provides to the first dataset, and based on similarity values, at least one term identifier associated with a second data term.

System 100 includes an information retriever 108, a hash transformer 112, a modifier 114, and an evaluator 120. In one example, the information retriever 108 includes a collection of nodes (e.g., Node 1 108(1), Node 2 108(2), . . . , Node V 108(v)). The information retriever 108 receives hash count 106 from a first dataset 102, where the first dataset 102 includes a first data term. The information retriever 108 provides hash count 110 to a second dataset 104, the second dataset 104 includes a plurality of second data terms (e.g., second data term 1, second data term 2, . . . , second data term X). The first dataset 102 may be interested in information related to k second data terms in the second dataset 104 that are most similar to the first data term. The information retriever 108, comprising Node 1 108(1), Node 2 108(2), . . . , Node V 108(v), provides secure information retrieval from the second dataset 104 to the first dataset 102.

The hash transformer 112 transforms the first data term and the plurality of second data terms. For example, the transformation of the first data term and the plurality of second data terms is based on hash count H. The integer H may be experimentally determined based on the type and number of data terms in the first dataset 102. In one example, the hash transformer 112 may be an orthogonal transformation. In one example, the hash transformer 112 may be a Walsh-Hadamard transformation (“WHT”). In one example, hash transformer 112 may apply a Walsh-Hadamard transform to the first data term and the plurality of second data terms to provide coefficients of the Walsh-Hadamard transform. In one example, the largest H coefficients (based on the hash count 106 and hash count 110) of the Walsh-Hadamard transform may comprise the transformed first data term and the plurality of transformed second data terms. In one example, the first data term may be transformed by a first hash transformer, and the plurality of second data terms may be transformed by a second hash transformer.

In one example, system 100 may be provided with values for hash count H and hash universe size U. Generally, U is a very large integer relative to H and N. In one example, U is a power of 2. In one example, hash transformer 112 may extend a numerical vector (e.g., the first data term, the plurality of second data terms) by concatenating it with itself d times, where d may be selected as a floor(U/N). In one example, the extension may include adding zeros so that the modified vector has U components. In one example, H may be 100, N may be 6000, and U may be 2¹⁸. Accordingly, d=floor(2¹⁸/6000). In one example, each 6000-dimensional vector (N=6000) may be associated with 100 integers (H=100) selected from the set {1, 2, 3, . . . , 2¹⁸} (U=2¹⁸). Accordingly, the hash transformer 112 transforms a higher dimensional data term (e.g. with 6000 dimensions) with a lower dimensional transformed data term (e.g. with 100 dimensions).

In one example, modifier 114 modifies, for a given node of the collection of nodes, the transformed first data term and the plurality of transformed second data terms respectively, the modification based on the given node. For example, modifier 114 may modify the transformed first data term to generate V modified first data terms 116, one for each node in the information retriever 108. Likewise, modifier 114 may modify each of the plurality of transformed second data terms to generate X*V plurality of transformed second data terms 118, one for each node in the information retriever 108. In one example, the first data term may be modified by a first modifier, and the plurality of second data terms may be modified by a second modifier.

In one example, the first data term and each of the plurality of second data terms may be a vector with length equal to the hash count H, and the modified first data term and each of the plurality of modified second data terms may be a sub-vector of the respective vector. For example, if the transformed first data term is represented as a vector a and a transformed second data term of the plurality of transformed second data terms is represented as a vector b, each having length H, then modifier 114 may partition vectors a and b into V sub-vectors with each sub-vector having length H/V, where H is assumed to be divisible by V for simplicity. Accordingly, transformed vectors a and b may be represented with V components as follows:
a=(a₁, a₂, . . . , a_{V}), b=(b₁, b₂, . . . , b_{V}).

For each node i, 1≦i≦V, modifier 114 may extract information from (V−1) sub-vectors and leave one sub-vector out from both a and b. For example, for Node 1 108(1), modifier 114 may extract the first component of vectors a and b to provide modified vectors ã₁, \tilde{b}₁, respectively, where:
ã₁=(a₂, . . . , a_{V}), \tilde{b}₁=(b₂, . . . , b_{V}).

Likewise, for Node 2 108(2), modifier 114 may extract the second component of vectors a and b to provide modified vectors ã₂, \tilde{b}₂, respectively, where:
ã₂=(a₁, a₂, . . . , a_{V}), \tilde{b}₂=(b₁, b₂, . . . , b_{V}).
   and so forth for each node of the plurality of nodes. Note that one different sub-vector may be left out for each node; accordingly, each sub-vector may be left out once and only once. Based on such extraction, modifier 114 generates V modified first data terms 116, one for each node in the information retriever 108. Likewise, modifier 114 may modify each of the plurality of transformed second data terms to generate X*V plurality of transformed second data terms 118, one for each node in the information retriever 108. Accordingly, in one example, the modification may be based on the number of nodes V in the collection of nodes.

In one example, modifier 114 provides, to the given node, the modified first data term and the plurality of modified second data terms. In one example, modifier 114 provides modified first data term 1 such as ã₁ to Node 1 108(1), and modified second data term 11 such as \tilde{b}₁ to Node 1 108(1). Likewise, Node 2 108(2) may receive a modified first data term with the second component extracted, and modified second data terms with the respective second components extracted. Accordingly, Node 1 108(1) receives modified first data term 1, and a plurality of modified second data terms 11, 21, . . . , X1; Node 2 108(2) receives modified first data term 2, and a plurality of modified second data terms 12, 22, . . . , X2, and Node V 108(v) receives modified first data term V, and a plurality of modified second data terms 1V, 2V, . . . , XV.

In one example, system 100 includes an evaluator 120 to evaluate, for each node, a similarity value between the first data term and each given second data term, the similarity value indicative of proximity of the given second data term to the first data term, and based on shared data elements between the modified first data term and a given modified second data term associated with the given second data term. For example, to evaluate a similarity value between a and b, evaluator 120 may evaluate a similarity value between pairs of sub-vectors ã₁, \tilde{b}₁, ã₂, \tilde{b}₂, . . . , ã_{V}, \tilde{b}_{V} and so forth.

In one example, the modified first data term and each modified second data term is a sub-vector of same length, and the similarity value is a ratio of a number of shared data elements between the modified first data term and a modified second data term associated with the given second data term to the length. For example, if sub-vectors ã₁, \tilde{b}₁ share m data elements, then the similarity value for the pair ã₁,

$${\tilde{b}}_{1} is \frac{m}{H - H / V} .$$

In one example, a=(a₁, a₂, . . . , a_{V}), b=(b₁, b₂, . . . , b_{V}), may share M elements. A number of shared elements between aᵢ and bⱼ may be represented as uᵢⱼ, where 1≦i,j≦V, and in matrix form, a matrix A may be utilized to represent these shared elements. For example,

$$A = ( \begin{matrix}{u}_{11} & … & {u}_{1 V} \\ ⋮ & ⋱ & ⋮ \\ {u}_{V 1} & … & {u}_{VV}\end{matrix} ) = {( {u}_{ij} )}_{1 \leq i , j \leq V} .$$

Accordingly, Σ_{1≦i,j≦V} uᵢⱼ=M.

In one example, evaluator 120 evaluates an average similarity value by averaging over all the nodes, the similarity values between the modified first data term and the modified second data term associated with the given second data term. For example, to evaluate the average similarity value between the vectors a and b, evaluator 120 may average the similarity values between the pairs ã₁, \tilde{b}₁, ã₂, \tilde{b}₂, . . . , ã_{V}, \tilde{b}_{V}. Let

$$ζ = \frac{M}{H}$$

denote the similarity between a and b, and let ζᵢ denote the similarity between ãᵢ and \tilde{b}₁. Then,

$${ζ}_{i} = \frac{M - ( {u}_{i 1} + {u}_{i 2} + … + {u}_{iV} ) - ( {u}_{1 i} + {u}_{2 i} + … + {u}_{Vi} ) + {u}_{ii}}{H * \frac{V - 1}{V}} , \qquad ( Eqn . 1 )$$

Based on Eqn. 1, the average similarity between the vectors a and b over V nodes may be evaluated as:

$$\overline{ζ} = {\sum }_{i = 1}^{V} {ζ}_{i} / V = \frac{( V - 2 ) * M + {\sum }_{i = 1}^{V} {u}_{ii}}{( V - 1 ) * H} , \qquad ( Eqn . 2 )$$

with a range

$$[ \frac{V - 2}{V - 1} ζ , ζ ]$$

corresponding to Σᵢ₌₁^{V} uᵢᵢ=0 and Σᵢ₌₁^{V} uᵢᵢ=M.

In one example, the average similarity value, for the given second data term, may have a hypergeometric distribution. When a and b are vectors of length H, then there are H² pairs between each data element in a and each data element in b. Since the total number of shared elements between a and b is M, there are M matches among the H² pairs. The sum of the diagonal terms Σᵢ₌₁^{V} uᵢᵢ in matrix A correspond to (H/V)²*V pairs. The number of matches S out of the (H/V)²*V pairs then follows a hypergeometric distribution give as:

$$Pr \{ {\sum }_{i = 1}^{V} {u}_{ii} = S \} = \frac{( \begin{matrix}{( H / V )}^{2} * V \\ S\end{matrix} ) * ( \begin{matrix}{( H / V )}^{2} * ( {V}^{2} - V ) \\ M - S\end{matrix} )}{( \begin{matrix}{H}^{2} \\ M\end{matrix} )} , \qquad ( Eqn . 3 )$$

where S belongs to the set {0, 1, . . . , M}. Once the distribution of Σᵢ₌₁^{V} uᵢᵢ is known to be hypergeometric, it follows that the distribution of the average similarity value ζ̅ is also hypergeometric, since

$$Pr \{ \overline{ζ} = \frac{( V - 2 ) * M + S}{( V - 1 ) * H} \} = Pr \{ {\sum }_{i = 1}^{V} {u}_{ii} = S \} = \frac{( \begin{matrix}{( H / V )}^{2} * V \\ S\end{matrix} ) * ( \begin{matrix}{( H / V )}^{2} * ( {V}^{2} - V ) \\ M - S\end{matrix} )}{( \begin{matrix}{H}^{2} \\ M\end{matrix} )} , \qquad ( Eqn . 4 )$$

where S belongs to the set {0, 1, . . . , M}.

In one example, evaluator 120 provides the similarity values to the information retriever 108, and information retriever 108 provides to the first dataset, based on similarity values, at least one term identifier associated with a second data term. For example, Node 1 108(1) of information retriever 108 may retrieve at least one term identifier 122 from the second dataset 104, where the term identifier identifies a second data term (associated with a modified second data term processed by Node 1 108(1)), where the modified second data term processed by Node 1 108(1) is selected based on similarity values.

In one example, system 100 may include a ranker (not illustrated in FIG. 1) to rank, for each node of the collection of nodes, the plurality of second data terms based on respective similarity values. For example, for Node 1 108(1), the modified second data terms corresponding to the plurality of second data terms may be ranked based on the respective similarity values. In one example, each node of the collection of nodes may provide to the first dataset, a plurality of ranked term identifiers, and each ranked term identifier identifying a ranked second data term of the plurality of second data terms. For example, Node 1 108(1) of information retriever 108 may provide to the first dataset 102, the top k similarity values between the sub-vector ã₁ associated with the first data term and the plurality of sub-vectors associated with the plurality of second data terms. In one example, unique term identifiers associated with the plurality of second data terms, corresponding to the top k similarity values, may be provided to the first dataset 102. Likewise, Node 2 108(2), . . . , Node V 108(v) may provide unique term identifiers to the first dataset 102, based on the evaluated similarity values at each node.

In one example, the collection of nodes may provide to the first dataset, an aggregate ranking of the plurality of ranked term identifiers, aggregated over all nodes of the collection of nodes. For example, the collection of nodes may pool the top k similarity values from each node, and then select the top k similarity values over all nodes. In one example, such aggregate ranking may be performed by an entity that manages first dataset 102. For example, information retriever 108 may forward the top k similarity values from each node to a first hospital managing the first dataset 102, and the first hospital may then evaluate an aggregate ranking over all nodes.

In one example, the hash transformer 112 may transform the first data term and the plurality of second data terms based on a collection of permutations generated by the information retriever 108.

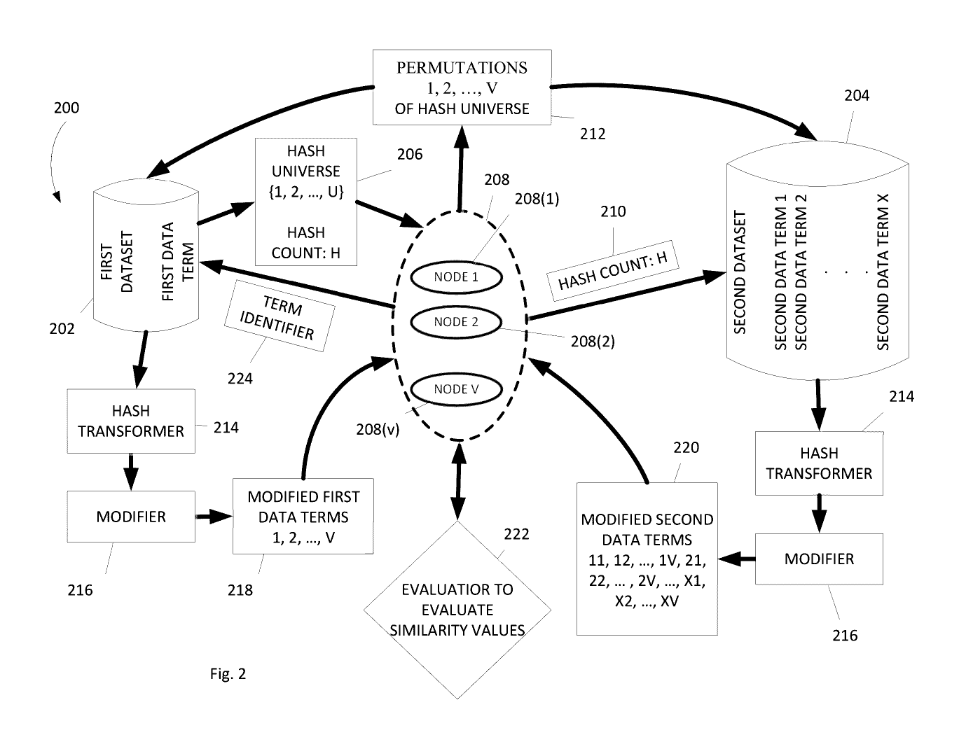

FIG. 2 is a functional block diagram illustrating another example of a system 200 for secure information retrieval. Some aspects of FIG. 2 may be described with reference to the system 100 described in FIG. 1. System 200 describes an example system where the information retriever generates a collection of permutations. As described herein (with reference to FIG. 1), information retriever 208 in system 200 includes a collection of nodes (e.g., Node 1 208(1), Node 2 208(2), . . . , Node V 208(v)). The information retriever 108 receives hash count H and hash universe {1, 2, . . . , U} 206 from a first dataset 202, where the first dataset 202 includes a first data term. The information retriever 208 provides hash count 210 to a second dataset 204, the second dataset 204 includes a plurality of second data terms (e.g., second data term 1, second data term 2, . . . , second data term X).

In one example, information retriever 208 generates a collection of permutations 212 of the hash universe {1, 2, . . . , U}, one permutation for each node of the collection of nodes. For example, Node 1 208(1) may generate a permutation P₁, Node 2 208(2) may generate a permutation P₂, and so forth. The collection of permutations 212 may be provided to the first dataset 202 and the second dataset 204.

In one example, as described herein, the hash transformer 214 further transforms, for each given node of the collection of nodes, the first data term and the plurality of second data terms based on a given permutation of the collection of permutations. For example, the transformation may comprise an extension of a numerical vector by concatenating it with itself to generate a vector of length U. In one example, hash transformer 214 may utilize permutation P₁ to generate a transformed first data term. For example, hash transformer 214 may extend the first data term (e.g. a numerical vector), apply permutation P₁ to the extended vector, and then apply an orthogonal transform such as WHT to generate a transformed first data term. Accordingly, based on permutations P₁, P₂, . . . , P_{V}, hash transformer 214 may generate V transformed first data terms, each a vector of length H, that are associated with the first data term. Likewise, hash transformer 214 may extend each second data term of the plurality of second data terms (e.g. numerical vectors), apply permutation P₁ to the extended vectors, and then apply an orthogonal transform such as WHT to generate a plurality of transformed second data terms. Accordingly, based on permutations P₁, P₂, . . . , P_{V}, hash transformer 214 may generate, for each second data term, V transformed second data terms, each a vector of length H. Accordingly, for the second data term 1, hash transformer 214 generates V transformed second data terms; for the second data term 2, hash transformer 214 generates V transformed second data terms, and so forth, thereby generating X*V transformed second data terms corresponding to the X second data terms in the second dataset 204.

In one example, the V transformed first data terms may be assigned randomly to the V nodes of the information retriever 208, and for each second data term, the V transformed second data terms may be assigned randomly to the V nodes of the information retriever 208.

As described herein, modifier 216 may modify, for each given node, the transformed first data term and the plurality of transformed second data terms respectively, the modification based on the given node. For example, a transformed first data term based on permutation Pᵢ may be partitioned into sub-vectors with each sub-vector having length H/V, where H is assumed to be divisible by V for simplicity. For example, transformed first data term based on permutation Pᵢ may be denoted as c and may be represented with V components as follows:
c=(c₁, c₂, . . . , c_{V}).

For each node i, 1≦i≦V, modifier 216 may extract information from (V−1) sub-vectors and leave one sub-vector out from c. Accordingly, modifier 216 may provide, to node j, a modified first data term 218 such as a sub-vector \tilde{c}ⱼ=(c₁, . . . c₍ⱼ₋₁₎, . . . , c₍ⱼ₊₁₎, . . . , c_{V}) associated with the first data term. The plurality of transformed second data terms may be modified in like manner to generate the plurality of modified second data terms 220.

The key difference in the transformed data term described with reference to hash transformer 112 (in FIG. 1) and hash transformer 214 (in FIG. 2) is that hash transformer 112 generates one transformed first data term, and modifier 114 modifies this one transformed first data term to provide V modified first data terms 116. However, with reference to system 200, hash transformer 214 generates V transformed first data terms, one for each permutation generated by each node. The V transformed first data terms are then randomly associated with the V nodes. Modifier 216 modifies the transformed first data term corresponding to a given node. Accordingly, modifier 216 modifies different transformed first data terms for different nodes to provide V modified first data terms 218.

Likewise, hash transformer 112 generates one transformed second data term for each second data term, and modifier 114 modifies this one transformed second data term to provide V modified second data terms for each node, thereby generating the modified second data terms 118. However, with reference to system 200, hash transformer 214 generates, for each second data term, V transformed second data terms, one for each permutation generated by each node. The V transformed second data terms for each second data term are then randomly associated with the V nodes. Modifier 216 modifies the transformed second data terms corresponding to each second data term and a given node. Accordingly, modifier 216 modifies different transformed second data terms for different nodes to provide X*V modified second data terms 220.

In one example, system 200 includes an evaluator 222 to evaluate, for each node, a similarity value between the first data term and each given second data term, the similarity value indicative of proximity of the given second data term to the first data term, and based on shared data elements between the modified first data term and a given modified second data term associated with the given second data term. In one example, evaluator 222 provides the similarity values to the information retriever 208, and information retriever 208 provides to the first dataset 202, based on similarity values, at least one term identifier 224 associated with a second data term in second dataset 204.

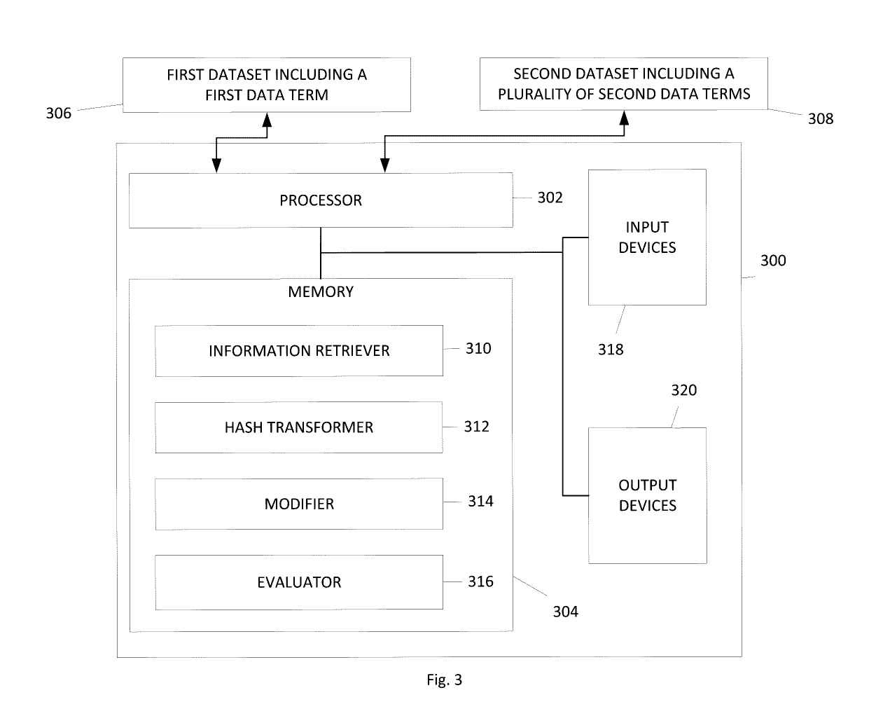

FIG. 3 is a block diagram illustrating one example of a processing system 300 for implementing the system 100 (or system 200) for secure information retrieval. Processing system 300 includes a processor 302, a memory 304, input devices 318, and output devices 320. Processor 302, memory 304, input devices 318, and output devices 320 are coupled to each other through communication link (e.g., a bus).

Processor 302 includes a Central Processing Unit (CPU) or another suitable processor. In one example, memory 304 stores machine readable instructions executed by processor 302 for operating processing system 300. Memory 304 includes any suitable combination of volatile and/or non-volatile memory, such as combinations of Random Access Memory (RAM), Read-Only Memory (ROM), flash memory, and/or other suitable memory.

In one example, memory 304 stores the first dataset 306 which may include a first data term. In one example, memory 304 stores the second dataset 308 which may include a plurality of second data terms. In one example, the first dataset 306 and the second dataset 308 may not be stored in memory 304. Instead, they may be stored on servers external to the processing system 300, and may be accessible to processor 302. For example, a storage medium associated with a first hospital may store the first dataset 306, and a storage medium associated with a second hospital may store the second dataset 308.

Memory 304 also stores instructions to be executed by processor 302 including instructions for an information retriever 310 where the information retriever 319 includes a collection of nodes, a hash transformer 312, a modifier 314, and an evaluator 316. Although not illustrated in FIG. 3, in one example, memory 304 also stores instructions for a ranker. In one example, information retriever 310, hash transformer 312, modifier 314, and evaluator 316, include information retriever 108, hash transformer 112, modifier 114, and evaluator 120, respectively, as previously described and illustrated with reference to FIG. 1, and include information retriever 208, hash transformer 214, modifier 216, and evaluator 222, respectively, as previously described and illustrated with reference to FIG. 2.

Processor 302 executes instructions of information retriever 310 to receive a hash count from the first dataset 306. In one example, processor 302 executes instructions of information retriever 310 to receive a hash count and a hash universe size from the first dataset 306. Processor 302 executes instructions of information retriever 310 to provide the hash count to the second dataset 308. In one example, processor 302 executes instructions of information retriever 310 to generate a collection of permutations of the hash universe, one permutation for each node of the collection of nodes. In one example, processor 302 executes instructions of information retriever 310 to randomly generate a given permutation of the collection of permutations. In one example, processor 302 executes instructions of information retriever 310 to provide the collection of permutations to the first dataset and the second dataset.

Processor 302 executes instructions of hash transformer 312 to transform the first data term and the plurality of second data terms, the transformation based on the hash count. In one example, processor 302 executes instructions of hash transformer 312 to transform, for each given node of the collection of nodes, the first data term and the plurality of second data terms based on a given permutation of the collection of permutations.

In one example, processor 302 executes instructions of a modifier 314 to modify, for a given node of the collection of nodes, the transformed first data term and the plurality of transformed second data terms respectively, the modification based on the given node. For example, processor 302 executes instructions of the modifier 314 to partition a numerical vector into V components, and generate sub-vectors by deleting one part for each node. Processor 302 executes instructions of the modifier 314 to provide, to the given node, the modified first data term and the plurality of modified second data terms.

In one example, processor 302 executes instructions of an evaluator 316 to evaluate, for each node, a similarity value between the first data term and each given second data term, the similarity value indicative of proximity of the given second data term to the first data term, and based on shared data elements between the modified first data term and a given modified second data term associated with the given second data term. In one example, the modified first data term and each modified second data term is a sub-vector of same length, and processor 302 executes instructions of an evaluator 316 to evaluate the similarity value as a ratio of a number of shared data elements between the modified first data term and a modified second data term associated with the given second data term to the length. In one example, processor 302 executes instructions of an evaluator 316 to determine an average similarity value by averaging over all the nodes, the similarity values between the modified first data term and the modified second data term associated with the given second data term.

Processor 302 executes instructions of information retriever 310 to provide to the first dataset, based on similarity values, at least one term identifier associated with a second data term.

In one example, processor 302 executes instructions of a ranker (not illustrated in FIG. 3) to rank, for each node of the collection of nodes, the plurality of second data terms based on respective similarity values. In one example, processor 302 executes instructions of information retriever 310 to provide, to the first dataset, a plurality of ranked term identifiers, each ranked term identifier identifying a ranked second data term of the plurality of second data terms. In one example, processor 302 executes instructions of information retriever 310 to provide, to the first dataset, an aggregate ranking of the plurality of ranked term identifiers, aggregated over all nodes of the collection of nodes.

Input devices 318 include a keyboard, mouse, data ports, and/or other suitable devices for inputting information into processing system 200. In one example, input devices 318 are used to input a query term. For example, a user at a first hospital may interact with processing system 300 via input devices 318 to securely retrieve information associated with a second hospital. Output devices 320 include a monitor, speakers, data ports, and/or other suitable devices for outputting information from processing system 300. In one example, output devices 320 are used to provide the top k-similar second data terms.

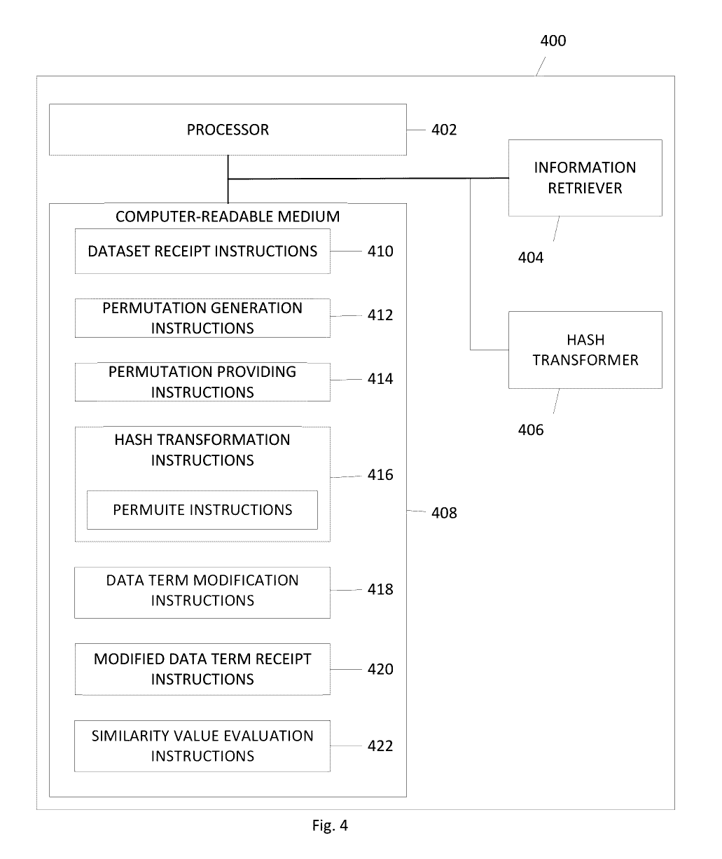

FIG. 4 is a block diagram illustrating one example of a computer readable medium for secure information retrieval. Processing system 400 includes a processor 402, a computer readable medium 408, an information retriever 404, and a hash transformer 406. Processor 402, computer readable medium 408, information retriever 404, and hash transformer 406 are coupled to each other through communication link (e.g., a bus).

Processor 402 executes instructions included in the computer readable medium 408. Computer readable medium 408 includes dataset receipt instructions 410 of the information retriever 404 to receive, at each node of a collection of nodes, a hash count from a first dataset, the first dataset including a first data term. In one example, the dataset receipt instructions 410 include instructions of the information retriever 404 to receive, at each node of a collection of nodes, a hash universe and a hash count from a first dataset, the first dataset including a first data term. The dataset receipt instructions 410 include instructions of the information retriever 404 to provide the hash count to a second dataset, the second dataset including a plurality of second data terms.

In one example, computer readable medium 408 includes permutation generation instructions 412 of the information retriever 404 to generate a collection of permutations of the hash universe, one permutation for each node of the collection of nodes. In one example, computer readable medium 408 includes permutation generation instructions 412 of the information retriever 404 to randomly generate a given permutation of the collection of permutations. In one example, computer readable medium 408 includes permutation providing instructions 414 of the information retriever 404 to provide the collection of permutations to the first dataset and the second dataset.

Computer readable medium 408 includes hash transformation instructions 416 of a hash transformer 406 to transform the first data term and the plurality of second data terms, the transformation based on the hash count. In one example, computer readable medium 408 includes permute instructions within the hash transformation instructions 416 of a hash transformer 406 to transform, for each given node of the collection of nodes, the first data term and the plurality of second data terms based on a given permutation of the collection of permutations. In one example, computer readable medium 408 includes hash transformation instructions 416 of a hash transformer 406 to apply an orthogonal transformation such as WHT to the first data term and the plurality of second data terms.

Computer readable medium 408 includes data term modification instructions 418 to modify, for a given node of the collection of nodes, the transformed first data term and the plurality of transformed second data terms respectively, the modification based on the given node. Computer readable medium 408 includes modified data term receipt instructions 420 to receive, at each given node of the collection of nodes, a modified first data term from the first dataset and a plurality of modified second data terms from the second dataset, the modified first data term and the plurality of modified second data terms based on the given node, the hash count and a given permutation of the collection of permutations.

Computer readable medium 408 includes similarity value evaluation instructions 422 to evaluate, for the given node, a similarity value between the first data term and each given second data term, the similarity value indicative of proximity of the given second data term to the first data term, and based on shared data elements between the modified first data term and a given modified second data term associated with the given second data term.

In one example, computer readable medium 408 includes instructions of the information retriever 404 to provide, to the first dataset, an aggregate ranking of a plurality of ranked term identifiers, aggregated over all nodes of the collection of nodes, wherein each term identifier identifies a ranked second data term of the plurality of second data terms.

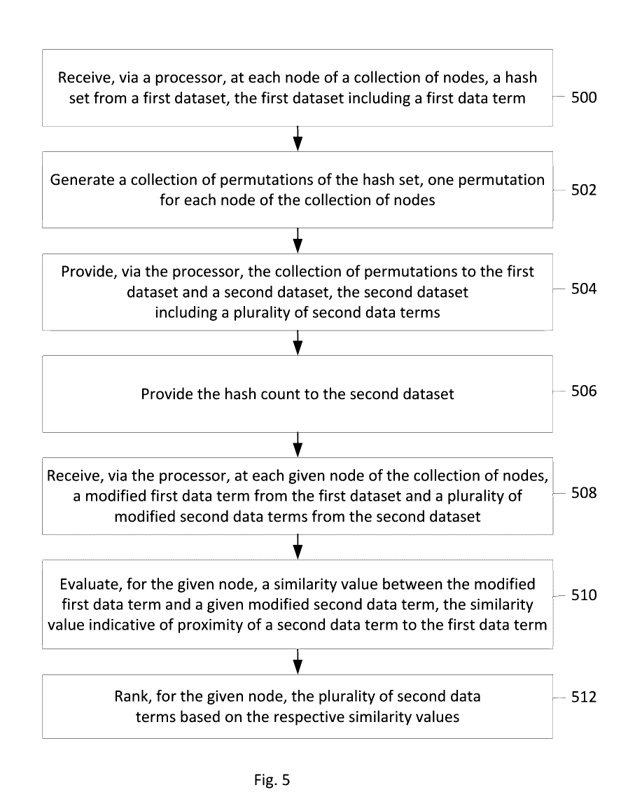

FIG. 5 is a flow diagram illustrating one example of a method for secure information retrieval. At 500, a hash set is received, from a first dataset, at each node of a collection of nodes, where the first dataset includes a first data term. At 502, a collection of permutations of the hash set is generated, one permutation for each node of the collection of nodes. At 504, the collection of permutations is provided to the first dataset and a second dataset, the second dataset including a plurality of second data terms. At 506, the hash count is provided to the second dataset. At 508, at each given node of the collection of nodes, a modified first data term is received from the first dataset and a plurality of modified second data terms are received from the second dataset. At 510, for the given node, a similarity value between the modified first data term and a given modified second data term is evaluated, the similarity value indicative of proximity of a second data term to the first data term. At 512, for the given node, the plurality of second data terms are ranked based on the respective similarity values.

In one example, for each node of the collection of nodes, a plurality of ranked term identifiers are provided to the first dataset, wherein each ranked term identifier identifies a ranked second data term of the plurality of second data terms.

Examples of the disclosure provide a generalized system for secure information retrieval. The generalized system provides a protocol to compute the similarity between objects from two entities in a secure and anonymized manner. As described herein, the proposed system is based on the principles of the hypergeometric distribution, orthogonal transform based hashing, and distributed retrieval. The systems and methods disclosed herein enable two entities to compute the similarity between their respective sets of objects without information leakage (i.e., sharing the information and/or features corresponding to the objects).

Although the examples are described with a first data term in the first dataset, the techniques disclosed herein may be applied to more than one data term in the first dataset. For example, the first data set may include a plurality of first data terms, and top k second data terms may be identified that are similar to the plurality of first data terms. Also, for example, although the examples are described with respect to a first dataset and a second dataset, the techniques may be applied to a plurality of datasets seeking to share information securely.

The proposed system is secure because the plurality of nodes perform the actual retrieval process (determining size of overlapping data elements) and report only the top-k similarity scores (overlap size) and unique identifiers to the first dataset. Accordingly, the first dataset does not determine the similarity values. The modification of the transformed data terms ensures that each of the plurality of nodes does not have complete data; so information may not be leaked by any of the nodes. Additionally, the hash transformation ensures that the plurality of nodes only have the hashes. Accordingly, the nodes are unable to regenerate the original data terms in the datasets (i.e., hash-to-data is not possible). The plurality of processing nodes compute the hash set overlap (no original object data is involved). The orthogonal transform based hashing is a probabilistic approach with a many-to-one transform. If hash parameters are chosen carefully (e.g. H<<N, N<<U, random permutations, and so forth) then there is no linear mapping between data elements in the original data term and the modified (hashed) data terms. Accordingly, in a worst case scenario where all the nodes of the plurality of nodes are non-trusted and leak the hashes to the first dataset, then the first dataset is still unable to regenerate the original object information in the second dataset.

Although specific examples have been illustrated and described herein, especially as related to numerical data, the examples illustrate applications to any dataset. Accordingly, there may be a variety of alternate and/or equivalent implementations that may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
an information retriever comprising a collection of nodes to:
receive a hash count from a first dataset, the first dataset including a first data term, and
provide the hash count to a second dataset, the second dataset including a plurality of second data terms;
a hash transformer to transform the first data term and the plurality of second data terms, the transformation based on the hash count;
a modifier to:
modify, for a given node of the collection of nodes, the transformed first data term and the plurality of transformed second data terms respectively, the modification based on the given node, and
provide, to the given node, the modified first data term and the plurality of modified second data terms;
an evaluator to evaluate, for each node, a similarity value between the first data term and each given second data term, the similarity value indicative of proximity of the given second data term to the first data term, and based on shared data elements between the modified first data term and a given modified second data term associated with the given second data term; and
the information retriever to securely provide to the first dataset, based on similarity values, at least one term identifier associated with a second data term.

2. The system of claim 1, further comprising a ranker to rank, for each node of the collection of nodes, the plurality of second data terms based on respective similarity values.

3. The system of claim 2, wherein each node of the collection of nodes provides to the first dataset, a plurality of ranked term identifiers, each ranked term identifier identifying a ranked second data term of the plurality of second data terms.

4. The system of claim 3, wherein the collection of nodes provides to the first dataset, an aggregate ranking of the plurality of ranked term identifiers, aggregated over all nodes of the collection of nodes.

5. The system of claim 1, wherein:
the collection of nodes further
receives a hash universe from the first dataset,
generates a collection of permutations of the hash universe, one permutation for each node of the collection of nodes,
provides the collection of permutations to the first dataset and the second dataset; and
the hash transformer further transforms, for each given node of the collection of nodes, the first data term and the plurality of second data terms based on a given permutation of the collection of permutations.

6. The system of claim 5, wherein the given permutation of the collection of permutations is generated randomly.

7. The system of claim 1, wherein the first data term and each of the plurality of second data terms is a vector with length equal to the hash count, and the modified first data term and each of the plurality of modified second data terms is a sub-vector of the respective vector.

8. The system of claim 7, wherein the modified first data term and each modified second data term is a sub-vector of same length, and the similarity value is a ratio of a number of shared data elements between the modified first data term and a modified second data term associated with the given second data term to the length.

9. The system of claim 8, wherein the evaluator determines an average similarity value by averaging over all the nodes, the similarity values between the modified first data term and the modified second data term associated with the given second data term.

10. The system of claim 9, wherein the average similarity value, for the given second data term, has a hypergeometric distribution.

11. The system of claim 1, wherein the modification is based on the number of nodes in the collection of nodes.

12. A method for secure information retrieval, the method comprising:
receiving, via a processor, at each node of a collection of nodes, a hash universe and a hash count from a first dataset, the first dataset including a first data term;
generating a collection of permutations of the hash universe, one permutation for each node of the collection of nodes;
providing, via the processor, the collection of permutations to the first dataset and a second dataset, the second dataset including a plurality of second data terms;
providing the hash count to the second dataset;
receiving, via the processor, at each given node of the collection of nodes, a modified first data term from the first dataset and a plurality of modified second data terms from the second dataset, the modified first data term and the plurality of modified second data terms based on the given node, the hash count and a given permutation of the collection of permutations;
evaluating, for the given node, a similarity value between the first data term and each given second data term, the similarity value indicative of proximity of the given second data term to the first data term, and based on shared data elements between the modified first data term and a given modified second data term associated with the given second data term; and
ranking, for the given node, the plurality of second data terms based on the respective similarity values.

13. The method of claim 12, further comprising providing, for each node of the collection of nodes, a plurality of ranked term identifiers to the first dataset, wherein each ranked term identifier identifies a ranked second data term of the plurality of second data terms.

14. A non-transitory computer readable medium comprising executable instructions to:
receive, via a processor, at each node of a collection of nodes, a hash universe and a hash count from a first dataset, the first dataset including a first data term;
generate a collection of permutations of the hash universe, one permutation for each node of the collection of nodes;
provide, via the processor, the collection of permutations to the first dataset and a second dataset, the second dataset including a plurality of second data terms, and providing the hash count to the second dataset;
receive, via the processor, at each given node of the collection of nodes, a modified first data term from the first dataset and a plurality of modified second data terms from the second dataset, the modified first data term and the plurality of modified second data terms based on the given node, the hash count and a given permutation of the collection of permutations; and
evaluate, for the given node, a similarity value between the first data term and each given second data term, the similarity value indicative of proximity of the given second data term to the first data term, and based on shared data elements between the modified first data term and a given modified second data term associated with the given second data term.

15. The non-transitory computer readable medium of claim 14, further comprising instructions to provide, to the first dataset, an aggregate ranking of a plurality of ranked term identifiers, aggregated over all nodes of the collection of nodes, wherein each term identifier identifies a ranked second data term of the plurality of second data terms.
